(19) United States
(12) Patent Application Publication
(10) Pub. No.: US 2026/0152372 A1
(43) Pub. Date: Jun. 4, 2026

(54) CRANE ARRANGEMENT

(71) Applicant: HIAB AB, Malmö (SE)

(72) Inventors: David Näslund, Täby (SE); Mattias Berglund, Hudiksvall (SE)

(73) Assignee: HIAB AB, Malmö (SE)

(21) Appl. No.: 19/327,207

(22) Filed: Sep. 12, 2025

(30) Foreign Application Priority Data
Sep. 19, 2024 (EP) 24201347.2

(51) Int. Cl. B66C 23/42; B66C 13/08; B66C 15/04

(52) U.S. Cl. CPC B66C 23/42; B66C 13/085; B66C 15/045

(57) ABSTRACT

Crane arrangement arranged to be mounted on a vehicle, the crane arrangement comprising a movable arm comprising a plurality of crane booms; a crane manoeuvring unit arranged to generate crane operation commands, such as commands for movements of the movable arm, based on received inputs by an operator of the crane arrangement; a positioning arrangement configured to determine the position of the crane manoeuvring unit, and to generate positioning signals in dependence thereto, and a crane controller arranged to monitor and control the movements of the movable arm in response to operation commands received from the crane manoeuvring unit and received positioning signals from the positioning arrangement. The crane controller is arranged to define at least one predefined two-or three-dimensional working space on said vehicle and/or on a trailer of said vehicle, wherein said working space(s) encloses a loading space of the vehicle and/or a loading space of a trailer attached to the vehicle. The crane controller is further configured to determine the position of the crane manoeuvring unit in relation to said working space(s), based upon the received positioning signals, wherein, if it is determined that the position of the crane manoeuvring unit is within said working space(s), the crane controller is configured to enter a safety operating mode resulting in that movements of the movable arm is halted or restricted, according to a set of movement limitation rules.

### TECHNICAL FIELD

The present invention relates to crane arrangements that are mounted on vehicles, particularly those that include advanced positioning and safety systems to control the movement of the cranes movable arm within predefined working spaces on the vehicle or a trailer attached to the vehicle.

### BACKGROUND

Cranes mounted on vehicles are widely used for various applications, such as loading and unloading materials. A key challenge in operating these cranes is ensuring safety and precision, particularly when the crane operates near critical areas, such as loading spaces on the vehicle or trailer.

The present invention is directed to loader cranes and the safety of the crane operator when operating the crane. The operator of the crane is typically standing next to the truck-mounted crane when operating it and moves around in the working area during the operations. The crane operator has conventionally a radio remote controller for operating the crane. Accidental or uncontrolled movements of the crane arm in these areas can lead to damage to the cargo, the vehicle, or even pose a risk to operators and bystanders. A number of incidents, and accidents, have been reported, where the operator is injured by the crane movements when operating the crane, and specifically when operating the crane while standing at the truck load bed or in other predefined areas (depending on the application, it could be certain areas where the operator could trip and fall or have limited sight of the operations or the surrounding).

Various solutions have been suggested in the prior art, stated to be applicable for avoiding the above-described situations.

For example, in EP3556712B, this has been addressed by selecting and controlling safety spaces with the manoeuvring unit wherein the manoeuvring unit itself could be used as a basis for defining one of these safety spaces.

U.S. Pat. No. 9,269,255B2 relates to worksite proximity warning configured to generate an alarm if first and second safety envelopes come in contact.

WO2010028938A1 discloses a mobile crane having support legs that can be controlled with a remote controller having an RFID reader. RFID-based transponders can be placed on appropriate positions on the support legs, such that when the remote controller is inside a safety zone, movement of the crane is stopped.

KR20180097023A discloses an overhead crane movement warning system for a rail-type crane, wherein the system comprises a control unit and a plurality of rail beacons attached to the traveling rail. The control unit is configured to slow down the crane movement if the worker is in proximity of the crane based on the sensor data from the worker (from its smartphone) and the movement of the crane.

US20130299440A1 discloses a tower crane with RFID technology for load management and collision avoidance. It employs at least four RFID components, including readers and tags, to measure distances and positions, ensuring safe operations. A key feature is its collision avoidance system, which continuously monitors the crane's surroundings using tag scanners. The crane will automatically stop if the load gets too close to other objects, preventing collisions.

The present invention addresses these challenges by integrating a crane controller that dynamically monitors the position of the crane's manoeuvring unit and restricts crane movements when the crane's manoeuvring unit is within predefined working spaces to enhance safety and operational efficiency.

The object of the present invention is to achieve an improved crane arrangement intended to address the above-described safety and operation problems, that provides a safe operational environment for the operator and at the same time ensures full controllability of the crane operation.

### SUMMARY

The above-mentioned objects are achieved by the present invention according to the independent claim.

Preferred embodiments are set forth in the dependent claims.

The present invention relates to a crane arrangement designed for mounting on a vehicle. The crane arrangement features a movable arm comprising several crane booms and is controlled by a crane manoeuvring unit. The crane manoeuvring unit generates crane operation commands based on inputs received from an operator. The arrangement also includes a positioning arrangement that determines the location of the crane manoeuvring unit and sends corresponding positioning signals to a crane controller. The crane controller is programmed to define at least one two-or three-dimensional working space, typically a loading space on the vehicle or its trailer. If the crane manoeuvring unit is detected within this predefined working space, the crane controller activates a safety operating mode, restricting or halting the crane's movements based on a set of predefined movement limitation rules.

In one embodiment the boundaries of the working space(s) are defined by a plurality of working space defining units, strategically mounted at the borders, or close to the borders, of the loading space. These units may use technologies such as radio wave time of flight technologies or optical distance measurement solutions to determine the distances between the crane manoeuvring unit and each working space defining unit. The crane controller then uses these distances to determine whether the manoeuvring unit is within or outside the predefined working space(s).

The herein described crane arrangement can be installed on a variety of vehicles, including trucks and trailers, to improve the safety and efficiency of loading and unloading operations. The precise control afforded by the crane controller, combined with the ability to define and enforce movement limitations within critical working spaces, makes this invention particularly valuable in industries where material handling and transport are key operations. The present invention also enhances the versatility of vehicle-mounted cranes, allowing operators to work more confidently and safely in environments where space is constrained, and the risk of accidental damage or injury is high.

### BRIEF DESCRIPTION OF THE DRAWINGS

FIG. 1 is a schematic illustration of a crane arrangement according to the present invention.

FIG. 2 is a schematic illustration of embodiments of the present invention.

### DETAILED DESCRIPTION

The crane arrangement will now be described in detail with references to the appended figures. Throughout the figures the same, or similar, items have the same reference signs. Moreover, the items and the figures are not necessarily to scale, emphasis instead being placed upon illustrating the principles of the invention.

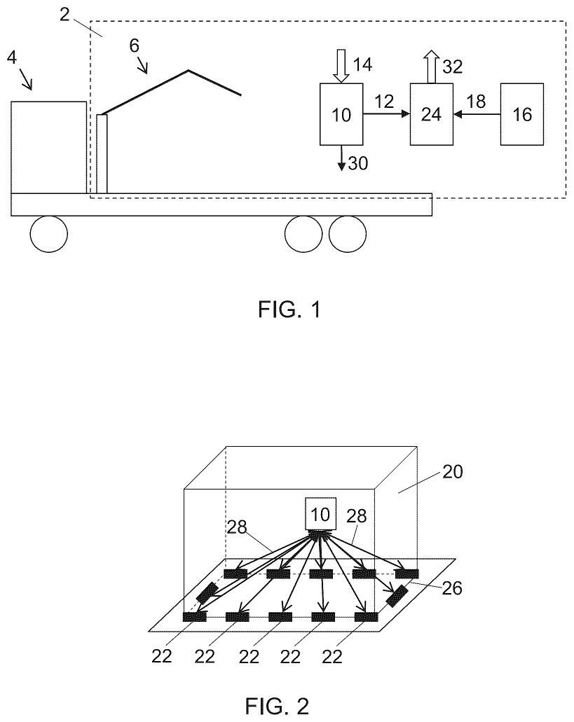

With reference to the schematic illustration shown in FIG. 1, the invention relates to a crane arrangement 2 arranged in relation to a vehicle 4, e.g. a loader truck.

The crane arrangement 2 comprises a movable arm 6 comprising a plurality of crane booms including a final crane boom with a crane boom tip. Conventionally, the movable arm is attached to a vertical crane pillar, and the crane booms may comprise one or many telescopically extendable booms.

The crane arrangement 2 further comprises a crane manoeuvring unit 10 arranged to generate crane operation commands 12, such as commands for movements of the movable arm 6, based on received crane operation inputs 14 by an operator of the crane arrangement 2. The crane manoeuvring unit 10 is conventionally a hand-held unit provided with numerous input members, e.g. a joystick, levers and/or buttons, that the operator uses for applying the crane operation inputs, and preferably also output members, e.g. a display, lamps, and audible/tactile members. Preferably, the crane manoeuvring unit 10 is provided with means for remote communication with other units of the crane arrangement, e.g. by using radio or optical communication technologies.

Thus, the crane manoeuvring unit 10 is the primary interface between the operator and the crane. This unit is designed to receive inputs 14 from the operator, such as joystick movements, button presses, or other control signals, and generate corresponding crane operation commands 12. These commands dictate the movements of the movable arm 6, including lifting, lowering, swinging, and extending operations.

The crane arrangement 2, further comprises a positioning arrangement 16 configured to determine the position in two or three dimensions of the crane manoeuvring unit 10, and to generate positioning signals 18 in dependence thereto.

Furthermore, the crane arrangement 2 also comprises a crane controller 24 arranged to monitor and control the movements of the movable arm 6 in response to operation commands 12 received from the crane manoeuvring unit 10 and positioning signals 18 received from the positioning arrangement 16.

The crane controller 24 is configured to generate control signals 32 to control the movements of the movable arm, and preferably also to control the operation of a tool attached to the crane boom tip. The control signals are conventionally applied to various actuators, e.g. hydraulic actuators, electro-hydraulic actuators, or electro-mechanical actuators, provided in relation to the movable arm.

Thus, the crane arrangement is equipped with a positioning arrangement 16, which is critical for ensuring safe and precise crane operations. The positioning arrangement is responsible for determining the exact location of the crane manoeuvring unit 10 relative to the vehicle 4 and any attached trailer. The positioning arrangement generates positioning signals 18 that are continuously fed to the crane controller 24.

The crane controller 24 is arranged to define at least one predefined two-or three-dimensional working space 20 on the vehicle 4 and/or on a trailer of vehicle 2. The working space(s) 20 is defined such that it encloses a loading space of the vehicle 4 and/or a loading space of a trailer attached to the vehicle 4. Thus, the working space encloses the entire loading space, but may also enclose additional safety spaces just outside the loading space. These additional safety spaces may be defined such that they cover a predetermined safety distance outside the loading space, e.g. 0-2.0 meters.

The crane controller is configured to determine the position of the crane manoeuvring unit 10 in relation to the working space(s) 20, based upon the received positioning signals 18. If it is determined that the position of the crane manoeuvring unit 10 is within the working space(s) 20, the crane controller 24 is configured to enter a safety operating mode resulting in that movements of the movable arm 6 is halted or restricted, according to a set of movement limitation rules.

The crane controller 24 is the central processing unit that controls the crane's operations. A key feature of the crane controller is its ability to define one or more predefined two-or three-dimensional working spaces 20 on the vehicle 4 or its trailer. These working spaces typically correspond to the loading areas where materials are placed or removed.

When the crane controller 24 determines that the crane manoeuvring unit 10 is within a predefined working space 20 based on the positioning signals 18, it triggers a safety operating mode. In this mode, the movements of the movable arm 6 are either halted or restricted according to a set of movement limitation rules.

For example, the movement of the crane tip or any part of the movable arm 6 may be completely halted to prevent any accidental contact with the operator, the load or vehicle. Alternatively, the crane controller may impose a speed limit on the crane arm's movements, ensuring that they occur at a slower, safer speed. These rules are designed to prevent damage and enhance safety when the crane is operating in critical areas. The predefined working space 20 may be defined as part of the installation and configuration of the crane arrangement on e.g. a truck. The working space 20 may be defined in relation to the positions where the working space defining units 22 have been mounted on e.g. the truck load bed or a trailer, but it does not necessarily require the working space defining units 22 to be at the border of the working space 20.

According to an embodiment, the crane arrangement 2 comprises a plurality of working space defining units 22 mounted at the border(s) 26, or close to the border(s) 26, of the loading space(s). The boundaries of the working space(s) 20 are defined by the positions of the working space defining units 22.

In a further embodiment, the positioning arrangement 16 and the working space defining units 22 are configured to apply radio wave or optical time of flight technology to determine the distances 28 between the crane manoeuvring unit 10 and each of the working space defining units 22. Alternatively, the distances may be determined by applying other technologies such as e.g. ultrasound or vision-based systems.

The radio time of flight technology, may be based on a round trip time between two measurement units wherein one measurement unit transmits a first signal and the other unit transmits another signal in response to receiving the first signal. Radio bands such as Ultra-wide band, Bluetooth or WiFi may be used. This technology will provide the necessary measurement accuracy required to obtain a reliable crane arrangement that fulfils high safety standards. The distances must be measured with a precision in the range of at least 1-10 centimetres.

In the implementation applied herein, each working space defining unit is provided with necessary circuitry required to perform the distance measurements, e.g. a radio wave or optical transmitters and/or receivers. The manoeuvring unit 10 may also be provided with such circuitry.

In another embodiment, the crane controller 24 is configured to determine the distances 28 between the crane manoeuvring unit 10 and each of said plurality of working space defining units 22, and then to determine if the manoeuvring unit 10 is within or outside said working space(s) 20 based upon the determined distances 28.

FIG. 2 shows a simplified set-up of embodiments according to the present invention. In the figure is shown a working space 20 defined by the positions of a plurality of working space defining units 22. In the figure, twelve working space defining units are mounted at a loader deck of the vehicle, positioned along the boundaries of a rectangle. The distances 28 between the manoeuvring unit 10 and each of the defining units 22 are determined by the crane controller 28, where the crane controller 28 may comprise a single processing unit or a system of units to which the crane controlling functionality is distributed. In the illustrated set-up, the working space has a three-dimensional shape, having rectangular sides, and a defined height. It should be noted that other geometrical shapes are possible, e.g. any shape having rounded edges, and also shapes that extends outside of the plane defined by the positions of the defining units 22. This is achieved because the surfaces of the working space are unambiguously defined by all determined distances between the manoeuvring unit 10 and each of the defining units 22. Although the example in FIG. 2 illustrates twelve different working space defining units, a smaller or larger number of units may be used. As an example, three units may be used to define the loadbed. If the working space defining units are arranged to manage further space defining parameters such as the orientation or direction in relation to a reference point in addition to the distance measurement than one working space defining unit could be sufficient. The crane controller is provided with a set of working space defining distances to be applied when determining whether the manoeuvring unit 10 is within, or outside, the working space. In FIG. 2, the working space defining units 22 are positioned in a common place. However, the working space defining units 22 may naturally, as an alternative, be positioned in a three-dimensional set-up, e.g. in the corners of a loading space.

In another embodiment, the crane controller 24 is configured to generate an indication signal 30, preferably via the manoeuvring unit 10, if it is determined that the position of the manoeuvring unit 10 is within the working space 20 when receiving input 14 to the manoeuvring unit 10 by an operator of the crane arrangement 2. This is beneficial as the operator then will receive a clear indication if he/she is within the working space which may be a dangerous position, as it alerts the operator that the crane is in a restricted operating zone, reinforcing the need for caution and adherence to the safety protocols in place. The indication signal may be a light signal, an audible signal, or a tactile signal.

In another embodiment, the set of movement limitation rules comprises a rule of halting the movement of a crane tip of the movable arm 6, or other part of the movable arm 2. And, in still another embodiment, the set of movement limitation rules comprises a rule of restricting the movement of a crane tip of the movable arm 6, or other part of the movable arm 6, to be slower than a predetermined movement speed.

According to another further embodiment, the crane controller 24 is configured to determine the position of the manoeuvring unit 10 in relation to the working space(s) 20 at a position determination rate being higher than a predetermined threshold rate such that continuous operation is ensured. The predetermined threshold rate will be at least some measurements per second. This high rate of position determination ensures that the crane can respond immediately to any changes in the operator's commands or the position of the manoeuvring unit.

The present invention also relates to a vehicle 4 comprising a crane arrangement 2 as described above.

Although the application discussed herein is directed to increase safety for the operator during operation of a crane arrangement, there may be further application areas of the positioning arrangement according to the invention. As a further example, in an arrangement with a vehicle and a working equipment operated by a remote/mobile manoeuvring unit, a problem for the operator may be to make sure that the manoeuvring unit is in the vehicle cabin before leaving the working site. By defining a space corresponding to the vehicle cabin, the vehicle controller and/or a controller of the working equipment, may be arranged to determine the position of the manoeuvring unit and generate an alarm/alert if the manoeuvring is not in the cabin when the vehicle is about to leave the working site, or even prevent the vehicle from moving.

The present invention is not limited to the above-described preferred embodiments. Various alternatives, and modifications may be used. Therefore, the above embodiments should not be taken as limiting the scope of the invention, which is defined by the appending claims.

1. Crane arrangement arranged to be mounted on a vehicle, the crane arrangement comprising:
a movable arm comprising a plurality of crane booms;
a crane manoeuvring unit arranged to generate crane operation commands, such as commands for movements of the movable arm, based on received inputs by an operator of the crane arrangement;
a positioning arrangement configured to determine the position of the crane manoeuvring unit , and to generate positioning signals in dependence thereto,
a crane controller arranged to monitor and control the movements of the movable arm in response to operation commands received from the crane manoeuvring unit and received positioning signals from the positioning arrangement, wherein the crane controller is arranged to define at least one predefined two-or three-dimensional working space on said vehicle and/or on a trailer of said vehicle, wherein said working space(s) encloses a loading space of the vehicle and/or a loading space of a trailer attached to the vehicle, and to determine the position of the crane manoeuvring unit in relation to said working space(s), based upon the received positioning signals, wherein, if it is determined that the position of the crane manoeuvring unit is within said working space(s), the crane controller is configured to enter a safety operating mode resulting in that movements of the movable arm is halted or restricted, according to a set of movement limitation rules.

2. The crane arrangement according to claim 1, comprising a plurality of working space defining units mounted at the border(s), or close to the border(s), of the loading space(s), and wherein the boundaries of said working space(s) are defined by the positions of said working space defining units .

3. The crane arrangement according to claim 2, wherein said positioning arrangement and said working space defining units are configured to apply radio wave time of flight technology to determine the distances between the crane manoeuvring unit and each of the working space defining units

4. The crane arrangement according to claim 2, wherein said crane controller is configured to determine the distances between the crane manoeuvring unit and each of said plurality of working space defining units, and then to determine if said manoeuvring unit is within or outside said working space(s) based upon said determined distances.

5. The crane arrangement according to claimany of claims 1, wherein said crane controller is configured to generate an indication signal (30), preferably via said manoeuvring unit, if it is determined that the position of the manoeuvring unit is within said working space when receiving input to the manoeuvring unit by an operator of the crane arrangement.

6. The crane arrangement according to claim 1, wherein said set of movement limitation rules comprises a rule of halting the movement of a crane tip of the movable arm, or other part of the movable arm.

7. The crane arrangement according to claim 1, wherein said set of movement limitation rules comprises a rule of restricting the movement of a crane tip of the movable arm, or other part of the movable arm, to be slower than a predetermined movement speed.

8. The crane arrangement according to claim 1, wherein said crane controller is configured to determine the position of the manoeuvring unit in relation to said working space(s) at a position determination rate being higher than a predetermined threshold rate such that continuous operation is ensured.

9. A vehicle comprising a crane arrangement according to claim 1.
